(19) United States
(12) Patent Application Publication
(10) Pub. No.: US 2006/0271377 A1
(43) Pub. Date: Nov. 30, 2006

(54) Seamless Transfer Technique

(76) Inventor: Steven Johnson, Rock Springs, WY (US)

Correspondence Address: STEVEN JOHNSON, 1993 DEWAR DRIVE, UNIT 1 PMB 274, ROCK SPRINGS, WY, 82901, US

(21) Appl. No.: 10/908,887

(22) Filed: May 31, 2005

(51) Int. Cl. G06Q 99/00

(52) U.S. Cl. 705/1

(57) ABSTRACT

The Seamless Transfer Technique is a real estate investment technique that allows an Investor to purchase a property and then re-sell the property to an end Buyer for a profit within a short period of time without breaking the chain of title. This is a accomplished by following a series of specific steps, and the use of two documents, an All Inclusive Option to Purchase Real Estate, and an Assignment and Contract.

### BACKGROUND OF THE INVENTION

Real Estate Investors have long been faced with the issue of “title seasoning”, that is, most mortgage lenders will not lend on a property that has changed hands more than once in the past 6 to 12 months. If an Investor purchases a property for a price below its fair market value, than re-sells the property for a profit within a few weeks, the end Buyer may have problems getting financing. In the past, Investors have used a variety of techniques to get around this issue, either by holding the property for the required amount of time before re-selling, or by selling the property with different types of “Seller financing”.

### BRIEF DESCRIPTION OF THE INVENTION

The Seamless Transfer Technique eliminates the issue of title seasoning and allows an Investor to purchase a property and then re-sell the property to an end Buyer for a profit within a short period of time without breaking the chain of title. This is accomplished by following a series of specific steps, and the use of two documents, an All Inclusive Option to Purchase Real Estate, and an Assignment and Contract.

### DETAILED DESCRIPTION OF INVENTION

Following is the step-by step process by which an investor would purchase and re-sell a property using the Seamless Transfer Technique:
(1) Investor obtains an option to purchase property from the owner using the proprietary All Inclusive Option to Purchase Real Estate along with the Assignment and Contract.
(2) Investor advertises property for sale and finds an end Buyer
(3) Assignment and Contract is completed and forwarded to Title Company or Closing Attorney.
(4) Investor exercises Option by presenting Seller (owner of Property) with valid Purchase Agreement from end Buyer.
(5) Transaction is funded and closed.

The All Inclusive Option to Purchase Real Estate includes specific verbiage which states that the Option may be exercised by the Investor presenting the Seller (owner of property) with a valid Purchase and Sale contract from an end Buyer. The Assignment and Contract is a separate notarized document by which the Seller (owner of the property) instructs the Title Company or Closing Attorney to pay any amount of the closing proceeds over and above the price specified to the Investor at closing in exchange for the release of the Option.

What is claimed is:

1. What I claim as my invention is the technique by which an Investor
1. uses an Option to Purchase Real Estate to secure the right of purchase to a property
2. exercises said Option by presenting the Seller (owner of Property) with valid Purchase Agreement from an end Buyer
3. uses an Assignment and Contract to release Option rights to the property in exchange for any amount of the closing proceeds over and above the price specified payable to the Investor at closing
